(19) United States
(12) Patent Application Publication
(10) Pub. No.: US 2006/0055833 A1
(43) Pub. Date: Mar. 16, 2006

(54) Overhead vehicle entertainment unit

(75) Inventors: Jong Min Lee, Gumi (KR); Chang Min Cho, Gumi (KR); Chun Rae Cho, Daegu-city (KR)

Correspondence Address: STEEPLE AUDIO, INC., 13570 BULLICK HOLLOW, AUSTIN, TX, 78726, US

(73) Assignee: KTV USA, INC.

(21) Appl. No.: 11/126,610

(22) Filed: May 11, 2005

Related U.S. Application Data
(60) Provisional application No. 60/609,503, filed on Sep. 13, 2004.

(51) Int. Cl. H04N 5/64

(52) U.S. Cl. 348/837

(57) ABSTRACT

An overhead vehicle entertainment unit is disclosed. The unit includes a housing for accommodating electronic components such as a control module, an audio module, a video module and an illumination module. A video display, such as an LCD panel, is pivotally attached to the housing. The housing is mountable in an interior of a motor vehicle, and includes at least one vent disposed on a side portion of the housing for allowing airflow to cool electronic components within the housing. A port is provided on a side portion of the housing for allowing a removable media source, such as a DVD, to be selectively inserted into and removed from the entertainment unit.

### RELATED APPLICATIONS

This application claims the benefit of U.S. Provisional Application Ser. No. 60/609,503 filed Sep. 13, 2004, the entire disclosure of which is expressly incorporated herein by reference.

### FIELD OF THE INVENTION

The present invention relates to the field of audio and video entertainment equipment, and, more particularly, to a self-contained entertainment unit for overhead installation in a motor vehicle.

### BACKGROUND OF THE INVENTION

Conventionally, entertainment units suitable for displaying audio and/or video information and for overhead installation within a passenger vehicle (e.g., automobiles, boats, aircraft, etc.) have been known. Examples of such entertainment units can be found in the following patents: U.S. Pat. No. 6,339,455 issued to Allan; U.S. Pat. Nos. 5,775,762, and 5,927,784 issued to Vitito; and U.S. Pat. Nos. 5,946,055, 6,059,255, 6,115,086, 6,124,902, 6,246,449 and 6,292,236 issued to Rosen. One disadvantage of these exemplary entertainment units is that they do not generally account for the benefits associated with keeping such units and their associated components cool during operative use. By way of example, the internal components of such units, including, for instance, the electronic components and the medium player, are typically confined and bunched together within a relatively small area. This configuration leaves very little room for air to circulate within the unit so as to allow for sufficient cooling of the electronic and other components. Extended exposure to heat can damage the unit or its associated components, as well as shorten the unit's life.

When entertainment units of the type described above are provided with a port or opening for selectively receiving an information memory medium, such as a digital video disc (DVD), it is often the case that enough clearance cannot be obtained between the opening and the mounting surface of the unit so as to enable effective utilization of the opening. This is disadvantageous because it makes insertion and retrieval of the medium (e.g., DVD) into and from the unit more difficult, thereby inviting damage to the medium. In addition, the port or opening is usually positioned directly within reach of a rear passenger compartment of the vehicle where children typically sit. This invites the rear passenger to unfasten his or her seatbelt so that he or she can operate the unit. Clearly, this creates a risk to the safety of the passenger. Moreover, the operator or front seat passenger of the vehicle (namely, an adult) would have little or no control of the medium being utilized with the unit. Accordingly, there is a need for an entertainment unit that addresses the aforesaid disadvantages and shortcomings.

### SUMMARY OF THE INVENTION

The present invention overcomes the disadvantages and shortcomings of the prior art discussed above by providing a new and improved overhead vehicle entertainment unit which includes a housing for accommodating, among other things, a control module, an audio module, a video module and an illumination module. The housing is configured for mounting in an interior of a passenger vehicle and is divided into portions that cooperate to compactly enclose any and all of the associated operating modules in an aesthetically appealing and user-friendly manner.

One beneficial feature of the present invention is its ability to keep cool and not overheat. In this regard, the housing of the entertainment unit includes a plurality of vents that allow for the entry of air into the unit for circulation. This venting effect advantageously cools the various components of the unit during operation. Moreover, a medium player (for example, a DVD player) employed by the unit is positioned separately from the other control modules, resulting in more open space within the housing. This allows for more air flow within the unit and, thus, achieves better cooling. Such additional space also allows for the inclusion of other cooling devices known in the art, such as fans, heat sinks, cooling pipes, etc.

Another beneficial feature of the present invention involves providing the housing with an ingress/egress port (i.e., an opening) for receiving an information memory medium, such as a DVD or memory card. The ingress/egress opening is advantageously located and/or oriented so as to effectuate access from a predetermined direction and inhibit access from other directions. More particularly, the opening is positioned in such a manner so as to give a user more clearance for inserting and retrieving the medium. Also, the opening is positioned away from the passenger compartment, which allows for better parental control of the unit and encourages the rear passenger (e.g., a child) to stay in his or her seat.

The control module can be operatively connected to existing vehicle electronics and/or operating systems. Thus, the operation of the entertainment unit may be influenced by conditions and/or systems associated with the vehicle to which the unit is coupled.

In accordance with still another beneficial feature of the present invention, the illumination module is directly and operatively connected to the control module and, as a result, indirectly connected to the vehicle's electronics and/or systems so as to be influenced thereby. For example, the illumination module of the unit may act as a replacement for the vehicle's interior dome lighting system.

In a similar fashion, the audio module and/or the video module may be directly and operatively connected to the control module and, as a result, connected to the vehicle's electronics and/or systems so as to be influenced thereby. Thus, the corresponding effects provided by each and every one of the aforementioned modules can be adjusted in response to manually and/or automatically controlled conditions.

According to yet another beneficial feature of the present invention, the video module includes a display screen, such as an LCD display, that is operatively connected to the housing such that it may be pivotally and adjustably positioned relative to the housing in any one of a number of positions. The unit includes a locking mechanism for locking the display screen in a housed position. The locking mechanism includes a slidable lock knob and latch mechanism that releases the display screen from its housed position to a deployed position.

Specifically, the present invention has been adapted for installation and use within an overhead surface of a motor vehicle. However, the present invention can be installed and/or used in other structures and environments, such the underside of a kitchen, office or RV cabinet, shelves, etc. Further features and advantages of the invention will appear more clearly upon a reading of the following detailed description of an exemplary embodiment thereof, which is given below by way of example only with reference to the accompanying drawings.

### BRIEF DESCRIPTION OF THE DRAWINGS

For a better understanding of the present invention, reference is made to the following detailed description of the exemplary embodiment considered in conjunction with the accompanying drawings, in which:

FIG. 1 is a functional block diagram according to an exemplary embodiment of the present invention;

FIG. 2 is a side perspective view of an overhead vehicle entertainment unit constructed in accordance with an exemplary embodiment of the present invention, showing a display employed by the unit in an operative position;

FIG. 3 is a first side elevational view of the entertainment unit shown in FIG. 2 with the display in an inoperative position;

FIG. 4 is a second side elevational view of the entertainment unit shown in FIG. 2, opposite the first side view of FIG. 3;

FIG. 5 is a plan view of the entertainment unit shown in FIG. 2 with the display in an inoperative position;

FIG. 6 is a plan view of a first housing cover employed by the entertainment unit shown in FIG. 2;

FIG. 7A is a plan view of a base and a second housing cover employed by the entertainment unit shown in FIG. 2;

FIG. 7B is a cross-sectional view, taken along section line A-A and looking in the direction of the arrows, of the base and second housing cover shown in FIG. 7A;

FIG. 7C is a cross-sectional view, taken along section line B-B and looking in the direction of the arrows, of the entertainment unit shown in FIG. 7A;

FIG. 8A is a perspective view of a lock knob employed by the entertainment unit shown in FIG. 2;

FIG. 8B is a side elevational view of the lock knob shown in FIG. 8A;

FIG. 8C is a top plan view of a locking mechanism for the display employed by the entertainment unit of FIG. 2, the locking mechanism being shown in its engaged position; and

FIG. 8D is a top plan view similar to FIG. 8C, except that the locking mechanism is shown in its disengaged position.

### DETAILED DESCRIPTION OF THE DRAWINGS

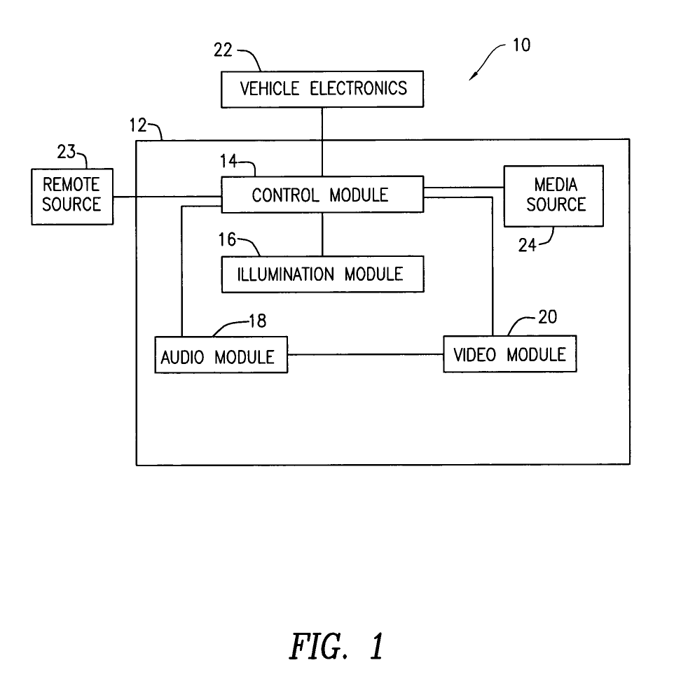

Referring to FIG. 1, there is shown an overhead vehicle entertainment unit 10 schematically illustrated, at least from an electronics/controls standpoint. More particularly, the entertainment unit 10 includes a housing 12 suitable for accommodating at least a control module 14, an illumination module 16, an audio module 18, and a video module 20. The control module 14 may cooperate with a vehicle's electronics and/or computer systems 22 so that one or more of the aforesaid modules may be influenced thereby. For example, the control module 14 can be operatively connected to the vehicle's electronics and/or computer systems 22 in any of a variety of ways including both wired and wireless connection types.

As shown, the control module 14 is operatively connected to each of the illumination module 16, the audio module 18, and the video module 20, so as to allow an operator or user to influence the operation of one or more of the modules. For instance, the control module 14 may be directly activated or, alternatively, may be indirectly activated via the vehicle's electronics and/or computer systems 22. Once the control module 14 is activated, information signaling by and between the various modules of the entertainment unit 10, as well as other remote sources, may be accomplished via the control module 14. For example, audio and/or visual signal information from a media source 24 (e.g., a DVD player or the like) can be received and directed to the audio module 18 and/or the video module 20, via the control module 14, so as to be appropriately reproduced for listening and/or observation. Similarly, audio and/or visual signal information from a remote source 23 (e.g., a broadcast station, a portable electronic device, etc.) can be received and directed to the audio module 18 and/or video module 20, via the control module 14, so as to be appropriately reproduced for listening and/or observation. For example, the audio module 18 may include an AM/FM tuner (not shown in the Figures). Furthermore, if better sound quality is desired, speakers operatively associated with the vehicle's audio system (not shown in the Figures) can be used to receive audio signal information from the audio module 18 by connecting the audio module 18 to the vehicle's audio system. Alternatively, or in addition, audio output cables (not shown) may be provided to allow auxiliary speakers to be connected to the audio module 18. Still further, in order to reduce the level of disturbance to the other individuals within the vehicle, wireless headphone transmitters or the like may be provided to broadcast the audio signal information to personal headphones.

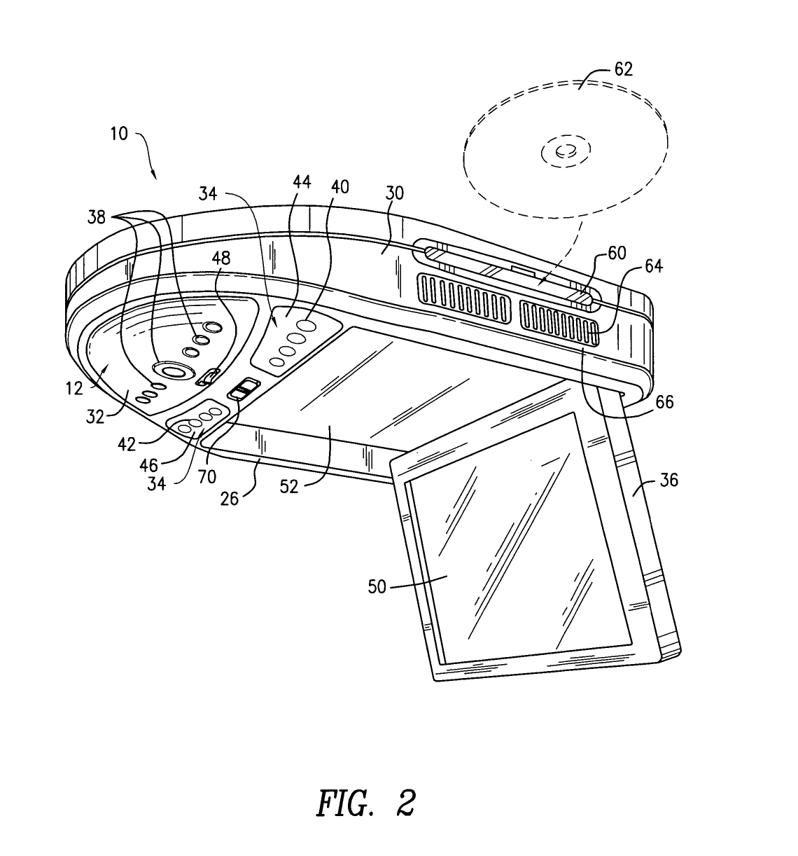

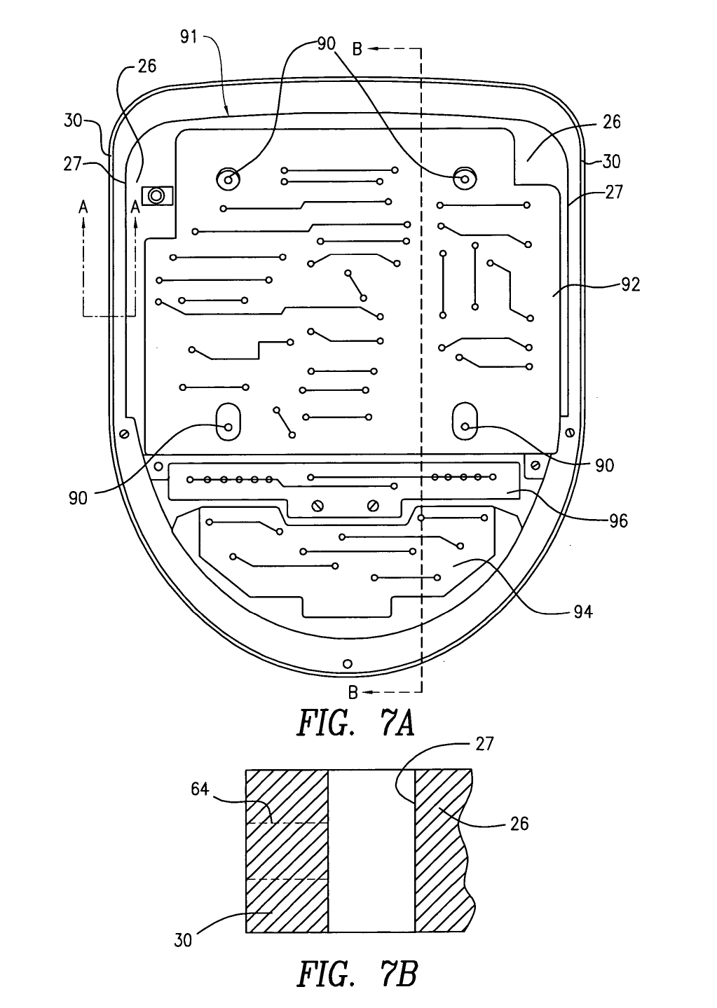

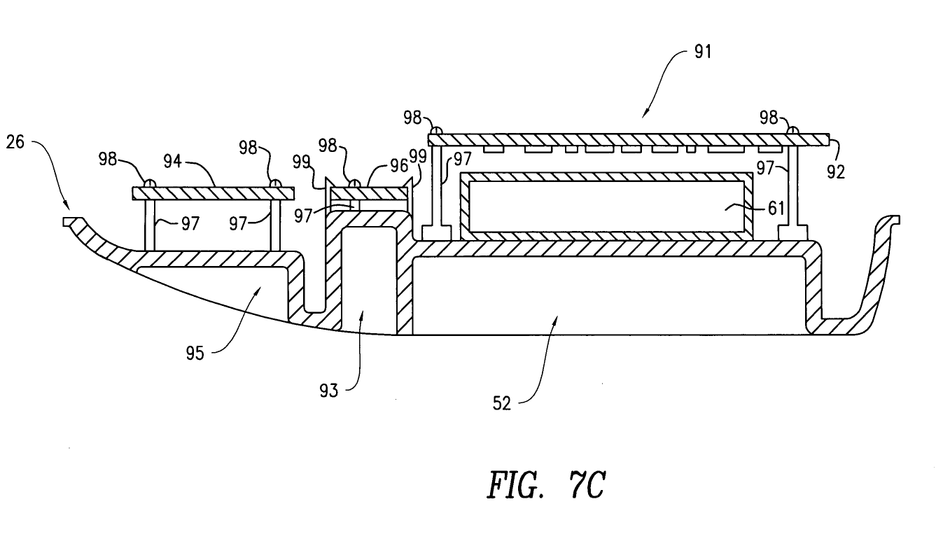

Referring now to FIGS. 2 through 7C, the housing 12 includes a base 26, which has a barrier wall 27 (FIGS. 7A, 7B) formed about its periphery; a first housing cover 28; and a second housing cover 30. As shown in the FIGS. 2 through 5, the base 26 and the housing covers 28, 30 are integrally connected to define a self-contained unit. Overall, the housing 12 is relatively rectilinear having rounded edges and smooth, sloping surfaces. However, the housing 12 can also have any of a variety of other configurations and/or geometries (e.g., circular, ovular, polygonal, etc.) suitable to provide a desired aesthetic effect and/or to accommodate various operating modules.

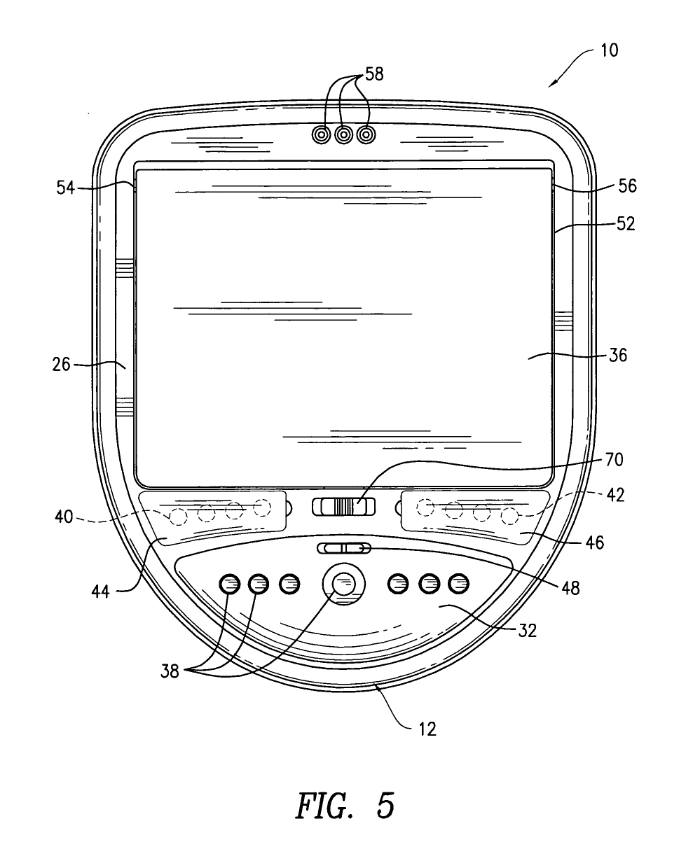

Referring now to FIGS. 2 and 5, the base 26 includes a majority of the electronic and mechanical components of the entertainment unit 10. More particularly, the base 26 includes a control panel 32 for providing a user with operative control of the entertainment unit 10, an illumination source 34 (see FIG. 2), and a display 36 for providing a user with means for observing visual images.

Still referring to FIGS. 2 and 5, the control panel 32 is a user interface operatively connected to the control module 14. The control panel 32, as shown in FIGS. 2 and 5, has a number of controls 38 including, for example: (i) a control for manually activating the entertainment unit 10; (ii) a control for changing operating modes (e.g., television mode, video mode, etc.); (iii) a control for accessing an operating menu and thereby allowing a user to effect the operation of the entertainment unit 10; (iv) a control for adjusting the visual display (e.g., brightness, color, contrast, etc.); (v) one or more controls for influencing an information media (e.g., play, stop, skip, eject, etc.); (vi) a control for selecting between different transmitted information signals (e.g., television channels, portable electronics, etc.); (vii) at least one control for influencing the sound effects provided by the entertainment unit 10 (e.g., volume); and/or (viii) a control for governing the overall operation of the entertainment unit 10 and/or the extent to which the entertainment unit 10 is operatively connected to the vehicle's existing electronics. The control panel 32 is preferably inclined at an angle to facilitate or enhance wireless (e.g., infrared or radio frequency) signal transmission and/or reception. A remote control device (not shown in the Figures) may cooperate with the control panel 32 and/or the control module 14 to enable a user to control the operation of the entertainment unit 10 from a remote location with respect thereto. In this regard, the control panel 32 may include an infrared receiver and transmitter (not shown in the Figures) to facilitate such cooperation. Alternatively, other transmitting and receiving devices known in the art can be utilized.

As may be recognized by those skilled in the pertinent art based on the teachings herein, additional and/or alternative control features may be used in order to provide greater flexibility and/or control during operative use of the entertainment unit 10. In addition, the controls 38 can take any of a variety of different forms (e.g., buttons, knobs, rotary dials, etc.) and may be back-lit so as to be readily discernable with respect to the control panel 32 irrespective of ambient lighting conditions.

Still referring to FIGS. 2 and 5, the illumination source 34, which forms part of the illumination module 16, is located adjacent the control panel 32 so as to illuminate the control panel 32 as desired. The illumination source 34 includes a pair of LED arrays 40, 42 to provide illumination. Each of the LED arrays 40, 42 cooperates with a corresponding filter 44, 46 so as to enhance the illumination provided thereby. Preferably, the filters 44, 46 are translucent, and include a diffraction pattern to disperse light (not shown in the Figures). Alternatively, the filters 44, 46 may have other characteristics. A switch 48 operatively associated with the illumination source 34 controls the flow of power to the LED arrays 40, 42. The switch 48, in combination with the LED arrays 40, 42, may act as a replacement for, or supplement of, the vehicle's interior dome lighting system (e.g., the standard “ON-DOOR-OFF” positions of the vehicle's interior lighting system).

It is preferable that the illumination source 34 consists of the LED arrays 40, 42, since LEDs use relatively low power, are long lasting and bright. As may be recognized by those skilled in the pertinent art based on the teachings herein, additional and/or alternative illumination sources may be used and/or operatively associated with the illumination module 16 to provide a variety of different illumination effects and facilitate more effective use of the entertainment unit 10. Further, the illumination source 34, in alternative aspects, can take any of a variety of different forms (e.g., incandescent lights, fiber optic lighting, etc.). Moreover, each of the LED arrays 40, 42 can consist of up to five LEDs. However, any number of LEDs can make up each of the LED arrays 40, 42.

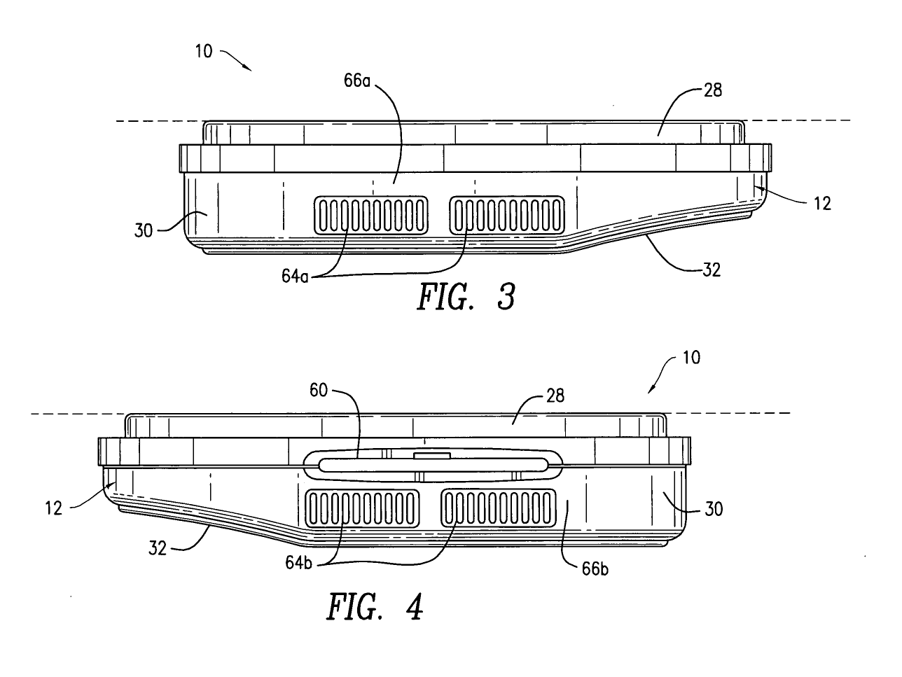

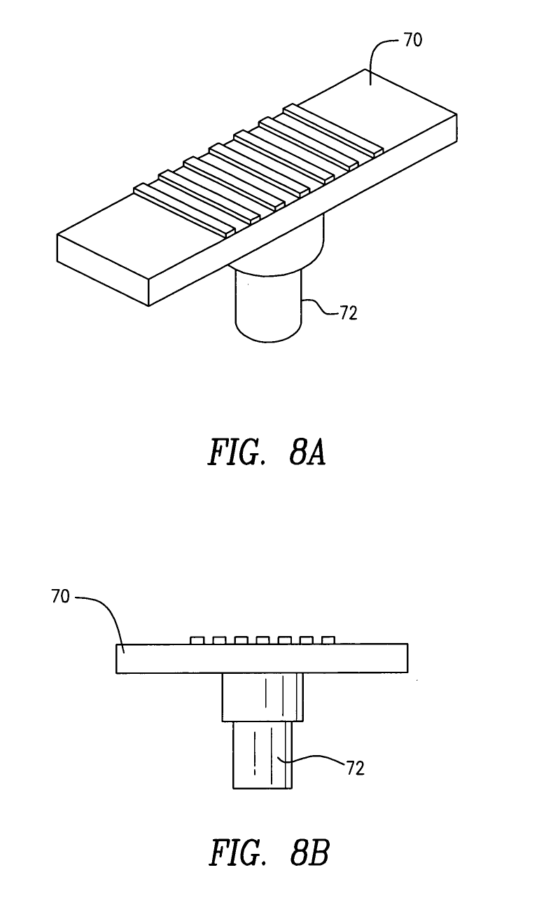

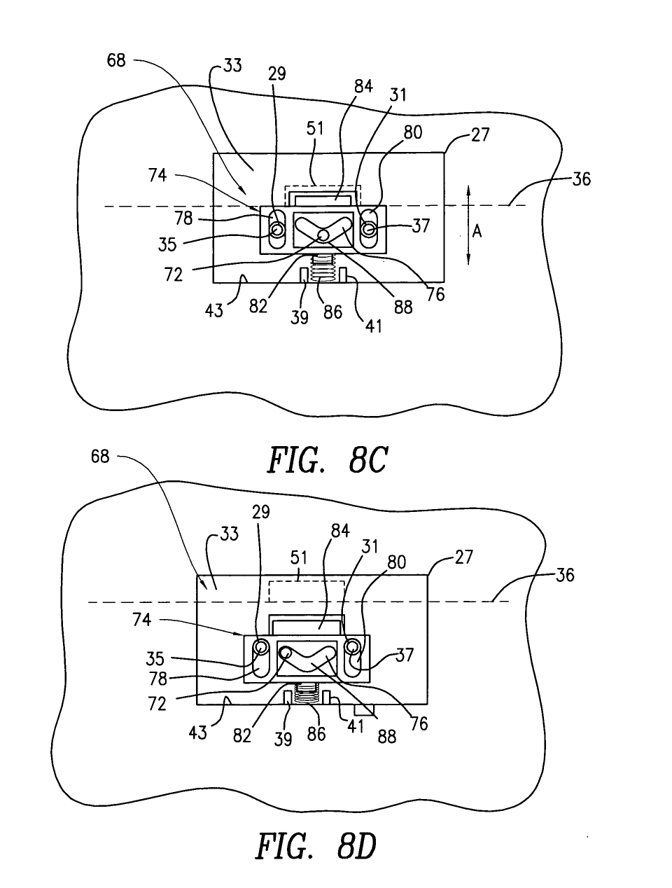

Referring to FIG. 2, the display 36 includes a screen 50 which is operatively associated with the video module 20 so as to display visual signaling information provided by immediate and/or remote signaling sources. The display 36 is movable between at least one open operating position, as shown in FIG. 2, and a closed inoperative position, as shown in FIGS. 3 and 4. In the open operating position of the display 36, the screen 50 is exposed and readily viewable. In its closed inoperative (stowed) position, the display 36 is received and accommodated by a stowage compartment 52 formed within the base 26 so that the screen 50 is both hidden and protected. The display 36 is attached to the base 26 by a pair of hinges 54, 56 (see FIG. 5). A rectangular-shaped notch 51 is provided in the display 36 for a purpose to be described hereinafter (see FIGS. 8C and 8D).

The screen 50 can be of any of a variety of known types including, for example, an LCD, an LED screen, a plasma screen, a CRT screen, or the like. As shown, the display 36 and the screen 50 have an overall rectilinear appearance. Nonetheless, both the display 36 and the screen 50 can have any of a variety of other shapes and/or sizes (e.g., circular, ovular, polygonal, etc.) suitable to complement the housing 12 and/or to provide a desired aesthetic effect.

Referring to FIG. 5, the base 26 further includes a plurality of input ports 58 located opposite the control panel 32. Alternatively, the input ports 58 may be positioned at any desired location on the base 26. The input ports 58 can include, for example, a multi-pin port suitable to allow for the integration of an external device with the entertainment unit 10, such as a video game console, hand-held movie camera, digital camera, etc. Another exemplary input port 58 might be an audio port suitable for transmitting audio signals to headphones or the like. In addition, any of a variety of different input ports 58, as well as a variety of internal input ports and/or output ports (not shown in the Figures), may be included as will be readily apparent to those of skill in the pertinent art from the teachings herein.

Referring to FIGS. 2 through 4 and 7A, the base 26 is coupled to the second housing cover, 30, leaving the control panel 32, the illumination source 34 and the display 36 exposed. The first housing cover 28 is coupled to the second housing cover 30 and the base 26 so as to enclose the remaining components of the unit 10, such as for instance, the delicate electronic components and the media source 24 (e.g., DVD player). The first housing cover 28 includes a plurality of notches 13 to allow for the passage of electrical wiring, plugs, and jacks of the entertainment unit 10 to the vehicle's electronics and/or computer systems 22 (see FIG. 1). It is noted that the base 26 and the first and second housing covers 28, 30 can consist of the same or different colors or patterns for aesthetics purposes, for instance, to match the entertainment unit 10 with the interior colors or patterns of the vehicle.

As shown in FIG. 7A, an interior compartment 91, which is defined by the housing covers 28, 30 (FIG. 2) and the base portion 26, houses a plurality of printed circuit boards 92, 94, and 96, each of which is coupled to the base portion 26 using any suitable fasteners, such as screws and the like, as will hereinafter be described. The boards 92, 94, and 96 contain circuitry associated with the modules shown schematically in FIG. 1, including the control module 14, the illumination module 16, the audio module 18, and the video module 20. More particularly, the board 92 includes circuitry associated with the audio module 18 and the video module 20. The board 94 includes circuitry associated with the control module 14. The board 96 includes circuitry associated with the illumination module 16.

FIG. 7C shows the relationship between the circuit boards 92, 94, and 96, the base portion 26, and a media player 61. The circuit board 94 is positioned above a recess 95 in the base portion 26, which recess receives the control panel 32 shown in FIG. 2 and associated controls. The circuit board 96 is positioned above a recess 93 in the base portion 26, which recess receives one of the light modules 34 shown in FIG. 2. Additionally, the circuit board 96 is also positioned above another recess (not shown) in the base portion 26, which recess receives the second light module 34 of FIG. 2. The circuit board 92 is positioned above the media player 61 and the stowage compartment 52, which receives the display panel 36 in a stowed position. The media player 61 receives the disc 62 shown in FIG. 2. The circuit boards 92, 94, and 96 are mounted to the base portion 26 using screws 98 and corresponding posts 97. Additionally, the circuit board 96 is mounted to the base portion 26 by snap-fit lugs 99. Of course, any desired mounting configuration known in the art could be utilized to mount the circuit boards 92, 94, and 96 to the base portion 26.

Referring now to FIGS. 8C and 8D, the base 26 further includes a rectangular-shaped chamber 27 having a pair of diametrically opposed, cylindrical-shaped posts 29, 31 extending from a wall 33 of the chamber 27. Each of the posts 29, 31 includes a corresponding mounting hole 35, 37. Rectangular-shaped partitions 39, 41 extend from a sidewall 43 of the chamber 27. The functions of the posts 29, 31, the holes 35, 37 and the partitions 39, 41 shall be described hereinafter.

Referring to FIGS. 2 and 4, the second housing cover 30 includes an ingress/egress portal or opening 60 for selectively receiving and accommodating an information medium, such as a memory card or disc 62, and a plurality of vents 64 for cooling the entertainment unit 10 during operative use. The ingress/egress opening 60, which is located and/or oriented so as to be accessible from a direction different from the direction by which the control panel 32 may be accessed, allows access to a media player 61 (see FIG. 7C). In addition, the ingress/egress opening 60 is sized, shaped and configured so as to effectively receive, accommodate and dispense a portable information medium, such as the disc 62 or other like media.

As may be recognized by those skilled in the pertinent art based on the teachings herein, additional and/or alternative ingress/egress openings may be used so as to accommodate a variety of different portable information media and thereby facilitate more flexible use of the entertainment unit 10. Further, the ingress/egress opening 60, in other aspects, can be inclined at an angle so as to further facilitate easy insertion and/or removal of the disc 62 from below the entertainment unit 10.

It is noted that the opening 60 is positioned in such a manner so as to give a user more clearance for inserting and retrieving the disc 62. Whether the entertainment unit 10 is flush mounted into the interior ceiling of the vehicle (whereby the first housing cover 28 is hidden within the ceiling) or surface mounted to the ceiling, the unit is sized and shaped to provide enough space for a user to insert the disc 62 into the opening 60. Also, the opening 60 is oriented away from the passenger compartment, thereby allowing for better parental control of the unit while discouraging the rear passenger (especially a child) from leaving his or her seat in an effort to access the unit.

Still referring to FIGS. 2 and 4, a first set of vents 64a is formed in sidewall 66a of the second housing cover 30 so as to facilitate a horizontal venting effect through the housing 12. As shown in FIGS. 3 and 4, a second set of vents 64b is formed in sidewall 66b opposite sidewall 66a. The vents 64a, 64b are positioned to facilitate a venting cross-flow through the housing 12 for cooling the various modules during operative use of the entertainment unit 10. This cross-flow venting effect may be enhanced through the utilization of the media player 61 (not shown), which is operatively associated with the ingress/egress opening 60. In addition, in other aspects of the present invention, a fan mechanism (not shown) may also be provided to further enhance the venting/cooling effect provided by the vents 64a, 64b. Further, the vents 64a, 64b can have various configurations and may be located at any of a variety of different locations throughout the housing 12 so as to provide varied venting effects. For instance, vents may be formed in an upper surface of the first housing cover 28 (not shown in the Figures). In addition, the unit 10 may include the vents 64a and not the vents 66a, and vice-versa (not shown in the Figures).

It is noted that the medium player employed by the entertainment unit 10 is positioned separately from the other control modules, resulting in more open space within the housing 12. This allows for more air flow within the entertainment unit 10 and, thus, achieves better cooling. Such additional space also allows for the utilization of other cooling mechanisms known in the art, such as heat sinks, fins, pipes, etc. (not shown in the Figures).

Referring to FIG. 7B, the barrier wall 27 of the base 26 functions to prevent a user from sticking an object (e.g., a screwdriver, paperclip, pin, etc.) into the vents 64a, 64b and making contact with the internal electrical, electronic and mechanical components of the entertainment unit 10. Not only does this configuration prevent a user from damaging such components, it prevents the user from receiving an electrical shock. It is noteworthy that while the design of the barrier wall 27 of the base 26 isolates the internal components, it simultaneously allows for the flow of air throughout the entertainment unit 10 as described in the preceding paragraphs.

Referring now to FIGS. 2, 5 and 8A through 8D, a locking mechanism 68 operatively associated with the housing 12 includes an external T-shaped lock knob 70, which has a cylindrical-shaped pin 72, and a complementary internal latch mechanism 74 operatively associated with the display 36. As shown in FIG. 8C, the latch mechanism 74 is positioned within the chamber 27 of the base 26 and includes a V-shaped cutout 76 having a central region 88 at the apex or “tip” of the V-shaped cutout 76, a pair of elongated slots 78, 80 arranged on opposite ends of latch mechanism 74, a nub 82 and a latch 84. The latch mechanism 74 is retained in position by the posts 29, 31, and moves freely in relation to the posts 29, 31, as indicated by arrow A. The slot 78 of the latch mechanism 74 receives the post 29, while the slot 80 of the latch mechanism 74 receives the post 31. The holes 35 and 37 receive corresponding screws and washers (not shown) to retain the latch mechanism 74 in position while allowing the latch mechanism 74 to move freely.

Still referring to FIGS. 8C and 8D, the lock knob 70 is engaged with the latch mechanism 74 such that the pin 72 of the lock knob 70 is fitted within the cutout 76 of the latch mechanism 74. A spring 86 is positioned around the nub 82 of the latch mechanism 74 such that one end of the spring 86 abuts against the latch mechanism 74, while an opposite end of the spring 86 abuts against the sidewall 43 of the chamber 27 of the base 26. The spring 86 is retained in position between the partitions 39, 41.

Referring to FIG. 8C, when the display 36 is in an inoperative position (i.e., when fully housed within the recess 52), the latch 84 of the latch mechanism 74 engages the notch 51 of the display 36. The pin 72 of the lock knob 70 is positioned within the central region 88 of the cutout 76. At this point, the spring 86 is decompressed and the forces asserted thereby maintain the engagement between the latch 84 and the notch 51 of the display 36, resulting in the display 36 being locked into its inoperative position, i.e., fully housed within the recess 52. Preferably, the latch 84 and the notch 51 are sized and shaped to maintain the foregoing configuration.

Referring to FIG. 8D, the display 36 is released from its inoperative position by sliding the lock knob 70 to urge the pin 72 away from the central region 88 of the latch mechanism 74. More particularly, a user can slide the lock knob 70 in either of two opposed lateral directions, thereby resulting in the pin 72 of the lock knob 70 traveling within the cutout 76 in a corresponding direction. Due to the angle of the legs of the cutout 76, the pin 72 forces the latch mechanism 74 to retract. As a result, the latch 84 is disengaged from the notch 51 of the display 36, thereby allowing the display 36 to be deployed in its operative position. When the lock knob 70 is released, the spring 86 forces the latch mechanism 74 back to its rest or home position. The latch 84 and the notch 51 are sized and shaped so that when the display 36 is returned to its inoperative position, the latch 84 engages the notch 51 by snapping into place and the display 36 is secured within the recess 52.

It is noted that when the display 36 is returned to its inoperative position, the unit 10 is powered off. Automatic on-off switches known in the art can be utilized to facilitate such procedure.

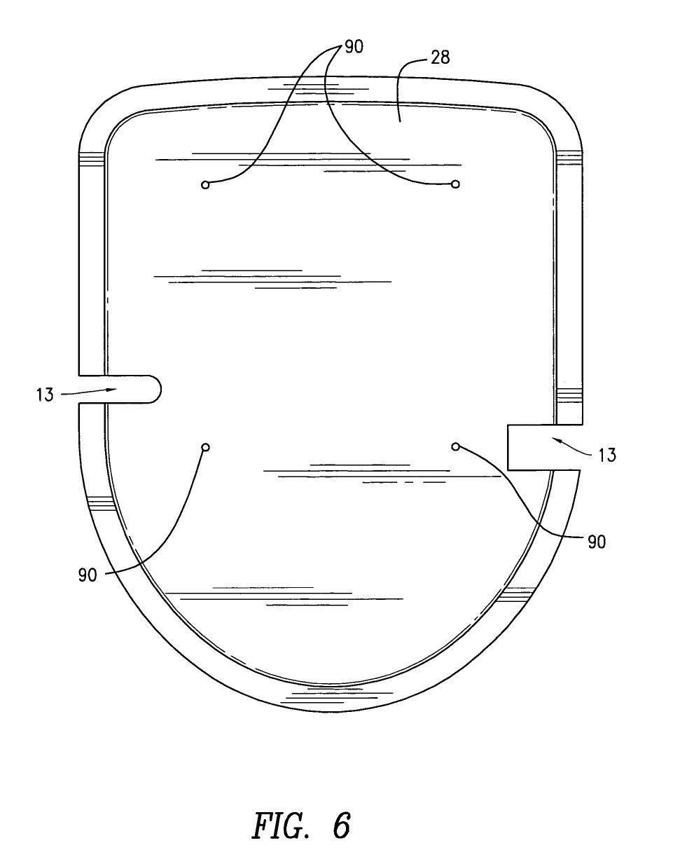

The housing 12 is suitable to be mounted to the roof of the vehicle by one or more fasteners (e.g., screws). As shown in FIGS. 6 and 7A, the entertainment unit 10 has a plurality of fastening apertures 90 suitable for cooperating with a corresponding number of fasteners (not shown) to secure the unit to the roof of the vehicle. The fastening apertures 90 run completely through the entertainment unit 10, that is, through the base 26 and through the housing covers 28, 30. This provides for strong and reliable mounting of the entertainment unit 10 to the vehicle. Preferably, the entertainment unit 10 includes four fastening apertures 90, but it can include more or less than four. Moreover, each of the fastening apertures 90 may be reinforced with metal for stronger mounting.

It will be understood that the embodiment described herein is merely exemplary and that a person skilled in the art may make many variations and/or modifications without departing from the spirit and scope of the present invention. All such variations and modifications are intended to be included within the scope of this invention.

What is claimed is:

1. An overhead vehicle entertainment unit, comprising:
a housing having an interior compartment;
a visual display mounted from said housing;
a plurality of electronic components mounted in said interior compartment of said housing, said plurality of electronic components being operatively associated with said visual display for reproducing video information thereon; and
venting means for venting said interior compartment.

2. The overhead vehicle entertainment unit of claim 1, wherein said housing further includes a front end positionable proximal to a front passenger compartment of a vehicle, a rear end positionable proximal to a rear passenger compartment of a vehicle, and a pair of sidewalls extending between said front and rear ends, said interior compartment being disposed between said pair of sidewalls.

3. The overhead vehicle entertainment unit of claim 2, wherein said venting means includes a first set of vents formed in one of said pair of sidewalls.

4. The overhead vehicle entertainment unit of claim 3, wherein said venting means includes a second set of vents formed in the other of said pair of sidewalls.

5. The overhead vehicle entertainment unit of claim 4, wherein said first and second sets of vents are arranged so as to provide cross-ventilation for said plurality of electronic components.

6. The overhead vehicle entertainment unit of claim 5, wherein said housing further includes a base portion having a periphery and a barrier wall extending around said periphery of said base portion.

7. The overhead vehicle entertainment unit of claim 6, wherein said barrier wall is positioned adjacent to said first and second sets of vents to inhibit foreign objects from being inserted into said interior compartment through said first and second sets of vents.

8. The overhead vehicle entertainment unit of claim 3, wherein said venting means includes a second set of vents formed in an upper surface of said housing.

9. The overhead vehicle entertainment unit of claim 2, wherein said plurality of electronic components includes a media player.

10. The overhead vehicle entertainment unit of claim 9, wherein one of said pair of sidewalls includes a portal positioned adjacent to said media player, said portal being sized and shaped so as to allow a media source to be inserted into said media player through said portal.

11. The overhead vehicle entertainment unit of claim 9, wherein said media player includes a fan operatively associated therewith, said fan cooperating with said venting means to enhance ventilation of said plurality of electronic components.

12. An overhead vehicle entertainment unit, comprising:
a housing having a front end positionable proximal to a front passenger compartment of a vehicle, a rear end positionable proximal to a rear passenger compartment of a vehicle, and a pair of sidewalls extending between said front and rear ends to define an interior compartment within said housing, one of said pair of sidewalls including a portal for receiving a media source;
a visual display mounted from said housing;
a media player mounted in said interior compartment adjacent said portal; and
a plurality of electronic components mounted in said interior compartment of said housing, said plurality of electronic components being operatively associated with said visual display and said media player for reproducing video information on said visual display.

13. The overhead vehicle entertainment unit of claim 12, wherein said housing further includes a base portion having a stowage compartment for receiving said visual display in a stowed position.

14. The overhead vehicle entertainment unit of claim 13, wherein said visual display depends from said base portion in a deployed position.

15. The overhead vehicle entertainment unit of claim 14, wherein said visual display is pivotable between said stowed position and said deployed position.

16. The overhead vehicle entertainment unit of claim 14, wherein said visual display is stowed by moving said visual display from said deployed position to said stowed position.

17. The overhead vehicle entertainment unit of claim 13, further comprising a circuit board having circuitry associated with said plurality of electronic components.

18. The overhead vehicle entertainment unit of claim 17, wherein said circuit board is mounted to said base portion above said media player when said entertainment unit is mounted to a vehicle ceiling.

19. The overhead vehicle entertainment unit of claim 18, wherein said stowage compartment is positioned below said media player when said entertainment unit is mounted to a vehicle ceiling.

20. The overhead vehicle entertainment unit of claim 12, wherein the other of said pair of sidewalls includes a first set of vents formed therein.

21. The overhead vehicle entertainment unit of claim 20, wherein said one of said pair of sidewalls includes a second set of vents formed therein, said first and second sets of vents being arranged to provide cross-ventilation of said plurality of electronic components.

22. The overhead vehicle entertainment unit of claim 20, wherein said housing further includes a second set of vents formed in an upper surface thereof.

23. The overhead vehicle entertainment unit of claim 12, wherein at least one of said plurality of electronic components is interconnected with at least one electrical system of said vehicle.

24. The overhead vehicle entertainment unit of claim 23, wherein at least one of said plurality of electronic components is controllable by said at least one electrical system of said vehicle.
